(19) United States
(12) Patent Application Publication
(10) Pub. No.: US 2020/0340192 A1
(43) Pub. Date: Oct. 29, 2020

(54) DRUM ASSEMBLY

(71) Applicant: Dickson Industries, Inc., Tecumseh, OK (US)

(72) Inventor: Wayne E. Dickson, Tecumseh, OK (US)

(21) Appl. No.: 16/858,210

(22) Filed: Apr. 24, 2020

Related U.S. Application Data
(60) Provisional application No. 62/839,632, filed on Apr. 27, 2019.

(51) Int. Cl. E01C 23/088; B02C 18/18; E01C 23/12; E01C 23/09

(52) U.S. Cl. CPC E01C 23/088; B02C 18/18; E01C 23/0885; E01C 23/09; E01C 23/127

(57) ABSTRACT

A cutter head comprises a drum body with a plurality of mounting slots defined in an outer face of the drum body. A plurality of cutter bits are removably connected to the drum body in at least a portion of the mounting slots. Filler plates are connected in any mounting slot that does not have a cutter bit connected therein.

There are a number of machines used for cutting, grinding and grooving surfaces such as a road surfaces. Often the surfaces are cut using machinery that rotates a cutter drum with bits attached thereto. The bits on existing cutter drums can wear quickly and are not easily replaced.

### DESCRIPTION OF THE DRAWINGS

FIG. 1 is a perspective view of the cutter head assembly.

FIG. 2 is a front view of the cutter head assembly.

FIG. 3 is a side elevation view of the cutter head assembly.

FIG. 4 is an enlarged view of cutter bits connected to the cutter drum.

FIG. 5 is a bottom view looking upward into the inside of a cutter drum connected to a carriage.

FIG. 6 is an additional embodiment of a cutter head assembly.

FIG. 7 is an enlarged view of the connection of cutter bits to a cutter drum.

FIG. 8 is an additional embodiment of a cutter head assembly.

FIG. 9 is an additional embodiment of a cutter head assembly.

FIG. 10 is a perspective view of a single cutter bit.

FIG. 11 is a side view of the cutter bit of FIG. 10.

FIG. 12 is a section view of the cutter bit of FIG. 10.

FIG. 13 is an additional embodiment of a cutter head assembly.

FIG. 14 is a side view of the embodiment of FIG. 13.

FIGS. 15-17 are views of an alternative cutter bit.

FIGS. 18-20 are views of an additional alternative cutter bit.

FIG. 21 shows a rotatable disc assembly with the cutter bits of FIGS. 18-20.

### SUMMARY

The current disclosure is directed to a cutter head assembly. The cutter head assembly is configured to connect to a piece of equipment that will rotate the cutter head assembly to make cuts, for example grooves or slots in a roadway. A cutter head in one embodiment comprises a drum body having a plurality of mounting slots defined in an outer face of the drum body. A plurality of cutter bits are removably and replaceably connected to the drum body in at least a portion of the mounting slots. In one embodiment cutter bits are connected in all of the mounting slots. In another embodiment filler plates are connected in at least some of the mounting slots.

In one embodiment the mounting slots are arranged in circumferential rows. The mounting slots in a circumferential row may be positioned to laterally overlap the mounting slots in adjacent circumferential rows. Each mounting slot may also be positioned to circumferentially overlap a slot that is laterally spaced therefrom. The mounting slots on the cutter head may be arranged in parallel V-shaped patterns.

In one embodiment the mounting slots comprise rectangular mounting slots with rounded corners. The filler plates and cutter bits may be connected to the drum with removable fasteners so that each are easily removed and easily replaced. The removable fasteners in one embodiment are threaded into threaded inserts fixed to the cutter drum to removably connect the filler plates and the cutter bits to the cutter drum.

In another embodiment a cutter head for rotatably connecting to a surface grinding machine comprises a cutter drum defining a plurality of mounting slots in an outer face thereof. A cutter bit is mounted in at least some of the mounting slots and the mounting slots are arranged such that each mounting slot laterally overlaps at least one laterally adjacent mounting slot. The mounting slots may also be arranged such that each mounting slot circumferentially overlaps at least one of the other mounting slots. The mounting slots may be arranged in lateral rows, and the mounting slots in a lateral row positioned to circumferentially overlap the slots in the circumferentially adjacent lateral rows. The mounting slots in a cutter drum may also be arranged in V-shaped patterns. The cutter bits are removable and replaceable. Threaded inserts may be installed in openings in the mounting slots, and the cutter bits connected to the cutter drum with threaded fasteners extending therethrough into the inserts.

In another embodiment a cutter head configured to connect to a surface grinding machine comprises a drum body. A plurality of mounting slots are defined in a drum face of the drum body, and the mounting slots are arranged in circumferential rows. Cutter bits are connected in at least some of the mounting slots and filler plates are connected in at least some of the mounting slots. At least one circumferential row has a filler plate connected in each of the mounting slots therein. In an embodiment of the cutter head the at least one circumferential row having a filler plate connected in each of the mounting slots therein is positioned so that the cutter head when in operation will result in two spaced apart cuts.

### DESCRIPTION

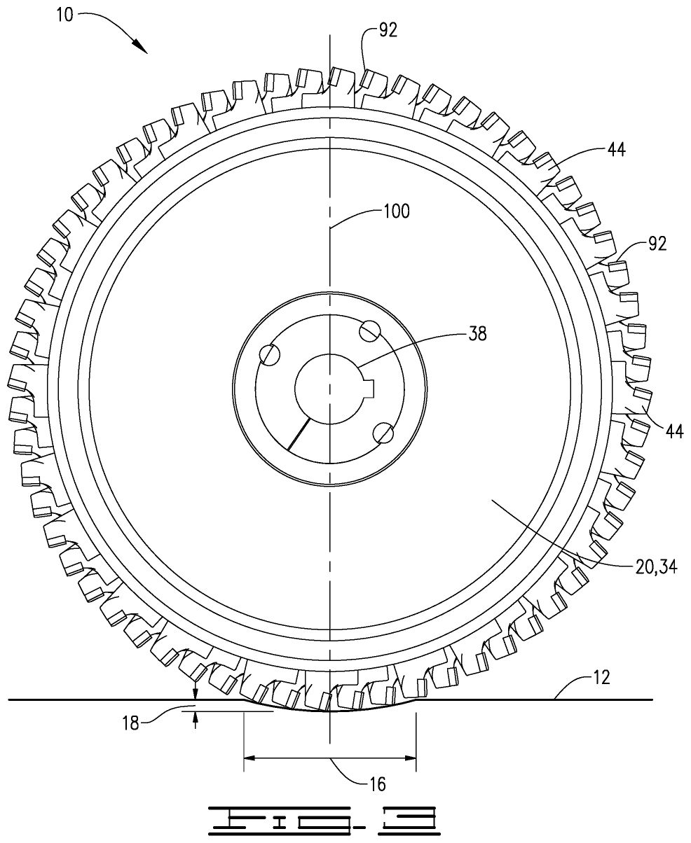

A cutter head assembly 10 configured to grind a portion of a surface 12 is shown. In the embodiment described the cutter head assembly 10 is configured to be connected to a machine and utilized to grind the surface 12 of for example, a roadway. The cutter head assembly 10 will be mounted utilizing a shaft as shown in the figures, and will be rotated by a motor as it is moved along a roadway. It is understood, however, that the cutter head assembly 10 can be configured to grind indoor and outdoor surfaces such as indoor floor surfaces and other outdoor surfaces other than a roadway. The cutter drum assembly 10 can be utilized to cut grooves in a surface 12 or to completely grind away the top portion of the surface being worked on. Uses may include for example, cutting grooves in a roadway on the shoulder or the center thereof, cutting slots for the insertion of reflectors in a roadway, cutting slots for road reflectors, removing paint lines and other uses. FIG. 3 shows an example of a groove 14 having a width 16 and depth 18.

Cutter head assembly 10 includes a cutter drum 15 with first side 20 and second side 25. Cutter drum 15 has a width 30 that extends between first and second sides 20 and 25 respectively. The width 30 may be varied depending upon the width of the cut desired.

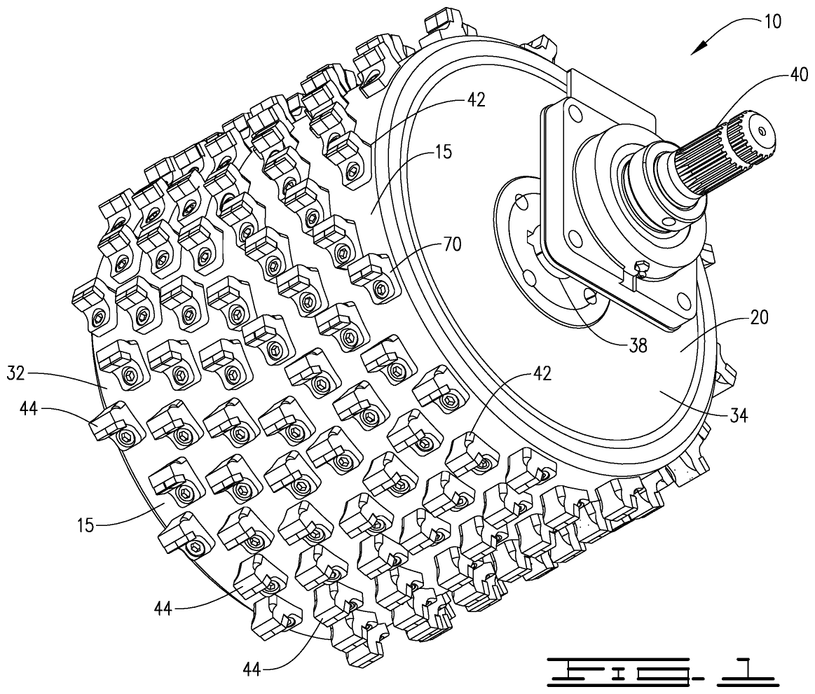

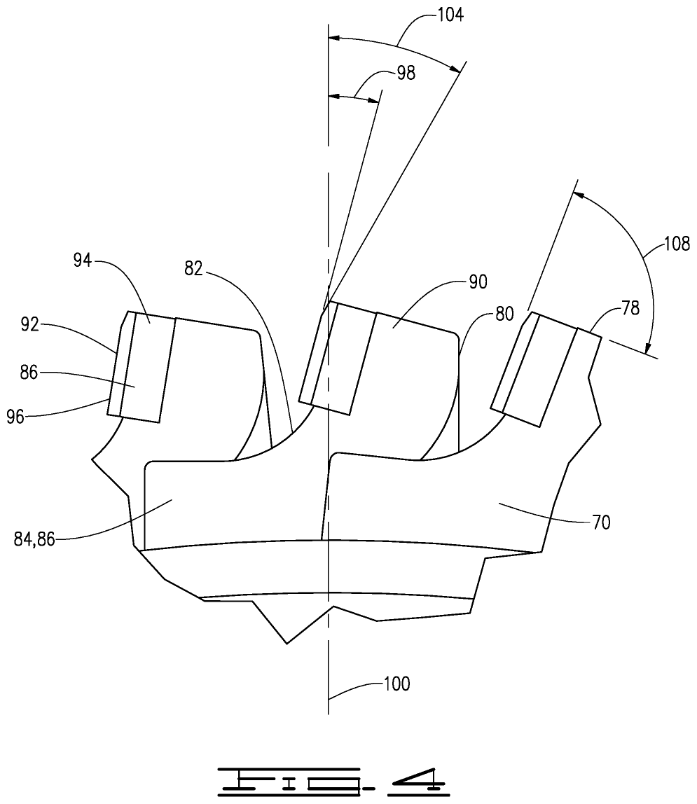

Cutter drum 15 includes a drum body 32 which is a generally cylindrical drum body 32 with a first side plate 34 and a second side plate 36 connected thereto. Side plates 34 and 36 may be connected by welding or other means known in the art. In the embodiment described, drum body 32 may be hollow which results in a cutter head assembly 10 generally much lighter than existing cutter head assemblies. First and second side plates 34 and 36 may have openings 38 therein with a key slot or other means for connecting a shaft 40 thereto. Drum body 32 has a drum face 42 thereon with a plurality of cutter bits 44 mounted thereto. Cutter bits 44 are removably mounted to cutter drum 15 so that worn cutter bits can be easily removed and replaced with a new cutter bit. In other words, cutter bits 44 are non-destructively replaceable. Drum face 42 may have a plurality of mounting slots 46 therein. An insert 48 is inserted by threading or otherwise into an opening in drum face 42 in mounting slot 46. FIG. 7 shows the attachment of cutter bits 44 to an embodiment of a cutter drum in mounting slots 46. In the embodiments shown in FIGS. 1-9 threaded fasteners 50 extend through openings in cutter bits 44 and are threaded into inserts 48. By utilizing removable and replaceable cutter bits 44 worn or damaged cutter bits are easily and efficiently replaced. Inserts 48 are likewise removable and replaceable, so that if an insert is worn or damaged, there is no need to replace or repair the cutter drum 15. All that is required is the removal and replacement of the insert 48. Mounting slots 46 are generally rectangular mounting slots with a width 52 and rounded corners 54. Rounded corners 54 prevent any stress concentrations and as a result lead to a longer cutter drum body life and a more robust, cutter head assembly 10 that is less subject to failures than existing assemblies. Mounting slots 46 have right and left sides 47 and 49, rear edge 51 and forward edge 53, and a depth 56.

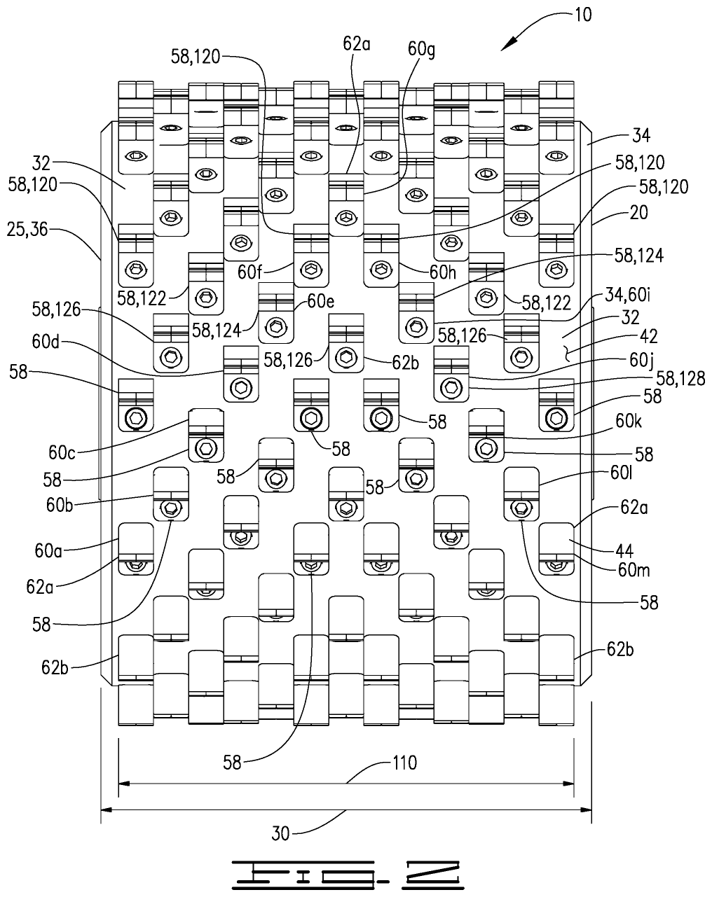

In the embodiment shown and described in FIGS. 1 and 2 mounting slots 46 and cutter bits 44 are arranged in a manner that may be described in different ways. Mounting slots 46 and the cutter bits 44 mounted therein are arranged in horizontal rows 58. Mounting slots 46 and cutter bits 44 mounted therein are also arranged in circumferential rows 60 and in V-shaped patterns 62 which are parallel V-shaped patterns 62.

While in the embodiment shown in FIGS. 1 and 2 each of mounting slots 46 has a cutter bit 44 mounted therein it is understood that some mounting slots may include a filler plate 64. As depicted in FIG. 7 filler plates 64 are mounted in any slot 46 in which no cutter bit 44 is mounted. Filler plates 64 are mounted with threaded fasteners threaded into inserts 48. In certain circumstances it may be desirable to create a narrower cut in a surface or spaced apart cuts with a single cutter head. In such a situation cutter bits 44 may be removed from certain of mounting slots 46 and replaced with a filler plate 64. In this way the mounting slots 46 are protected and may be used to later mount a cutter bit 44 therein. For example, removing cutter bits 44 from the two outer circumferential rows 60 at each side and replacing with filler plates 64 will result in a narrower cut than if cutter bits 44 are placed in all of the mounting slots. Spaced cuts in a surface may be made by, for example placing filler plates in the three center circumferential rows 60.

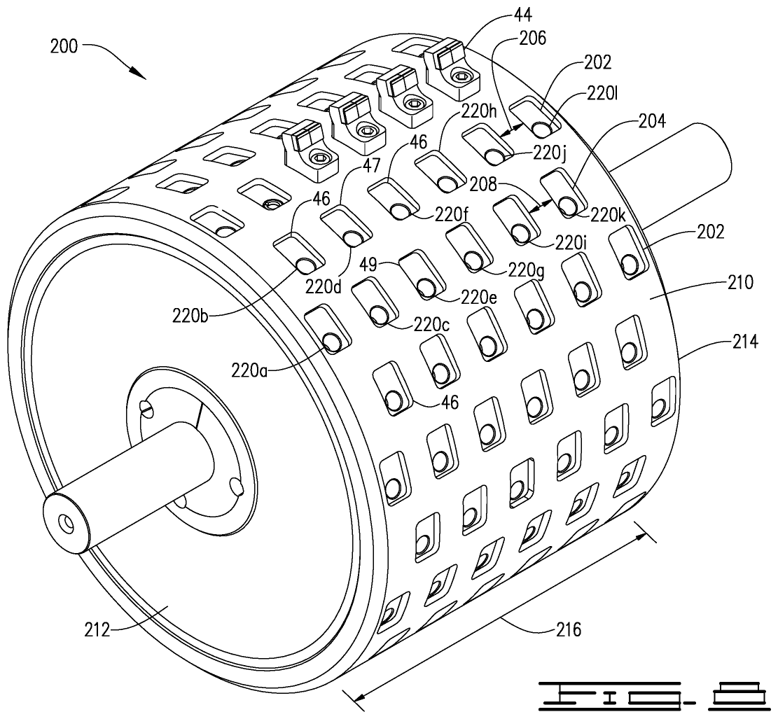

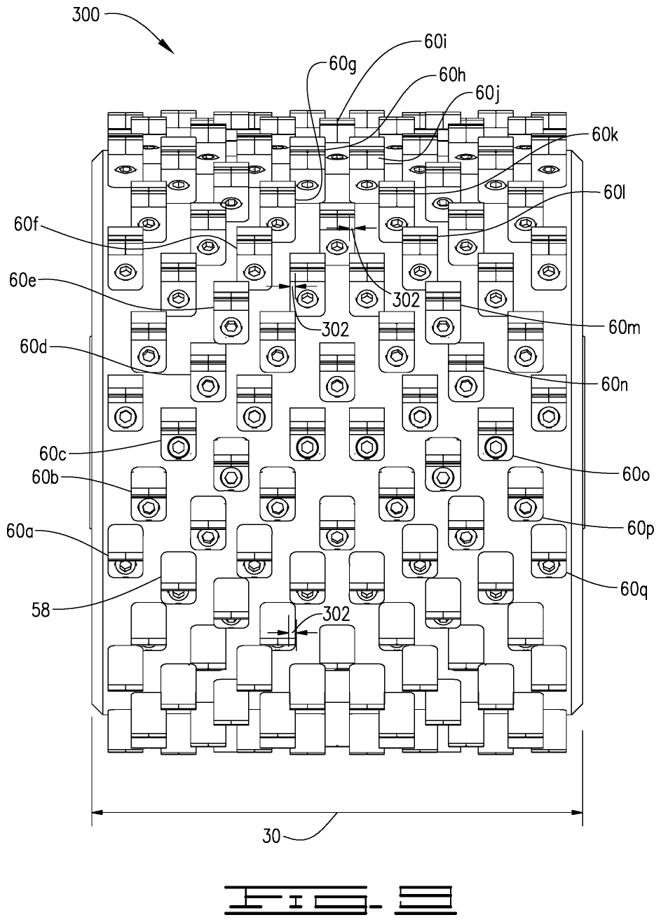

Referring to FIGS. 7 and 10 cutter bits 44 have a right or first side 70 and a second or left side 72. Cutter bits 44 have a bottom surface 74 that in the embodiment shown is a flat rectangular shaped bottom surface 74 with rounded corners 76. Bottom surface 74 is configured to be closely received in mounting slots 46 and to protect the bottom surface thereof. During rotation of the cutter drum assembly the edge of cutter bits 44 is engaged by rear slot edge 51 which drives the cutter bits 44 during the grinding/cutting of surface 12. In other words, fasteners 50 will carry very little load or force, if any, created when the cutter bits 44 engage and cut surface 12.

Cutter bit 44 has a top surface 78, a rear side 80 and a front or forward side 82. A forwardmost edge 83 is defined by forward side 82. Cutter bit 44 may be a multiple piece cutter bit that comprises a cutter bit body 84 and a cutter tooth 86 mounted thereto. Cutter bit body 84 may be made, for example, from forged steel, such as 4140 steel. Cutter bit 44 has base 88 with tooth portion 90 extending therefrom. Cutter tooth 86 is connected to and comprises a part of tooth portion 90.

A tooth face 92 is defined on cutter bit 44 and specifically on cutter tooth 86. Cutter tooth 86 is bonded to a connecting pad 94 which is made for example of carbide steel. Connecting pad 94 is mounted to body 84 by brazing or other known means. Cutter tooth 86 may be polycrystalline diamond (PCD) cutter tooth. The hardness of PCD results in a cutter bit 44 with a longer operating life than other cutter bits. In the embodiment described rear side 80 is generally perpendicular to bottom surface 74, so that an angle 98 is defined by a line 100 perpendicular to bottom surface 74 and tooth face 92.

Tooth face 92 is thus angularly offset from line 100 perpendicular to bottom surface 74 of the cutter bit 44. As a result when cutter bit 44 is at the cutting position namely, at a position at which cutter bit 44 is engaging the surface being cut, tooth face 92 is angularly offset from a line though the center of the cutter drum. The line through the center of the cutter drum will be collinear with line 100 in the position described and is perpendicular to the bottom surface 74. Thus angle 98 is defined by and between tooth face 92 and line 100. Angle 98 is generally between 10 and 20 degrees and in one embodiment about 15 degrees.

Cutter tooth 86 has a leading edge 106 that is angularly offset from tooth face 92. Leading edge 106 is offset by an angle 104 from line 100 which may be in the range, for example, of 25 to 35 degrees and in one embodiment about 30 degrees. Top surface 78 and tooth face 92 define an angle 108. Angle 108 is such that top surface 78 will not drag against the ground surface during the cutting motion. In other words, as the cutter drum 15 rotates and cuts into the surface 12 top surface 78 will not engage the ground surface 12. In the embodiment described angle 108 is for example between 85° and 95° and in one embodiment about 90°. As a result top surface 78 is offset from line 100 at about an angle of about 100° to 110° which allows the cutter tooth 44 to move through the cutting arc with no drag against surface 12 by top surface 78. This is in contrast to other prior art configurations which do not have the offset tooth face and as a result create drag and a greater impact when cutting. In any event, the angle can be any angle such that drag is reduced and/or eliminated. Although the type of cut described herein is a plunge cut, in other words, a groove created by a plunging action of the cutter head assembly 10 as it rotates and is moved along surface 12, cutter drum assembly 10 may be used to remove paint lines from roadway, cut slots for different types of markers and make other cuts to remove material from a surface.

In the arrangement shown in FIG. 2 there are a plurality of circumferential rows 60 and specifically thirteen rows 60 which are annotated with the letters a through m. In the embodiment of FIG. 2 the right side or first side 47 of mounting slots 46 is aligned with the left side 49 of mounting slots 46 in an adjacent circumferential row. As a result, the right side or first side 70 of a cutter bit 44 in a circumferential row 60 is aligned with the left side 72 of the cutter bit 44 in the adjacent circumferential row 60. For example, the right side 70 of cutter bits 44 in circumferential row 60e will align with the left side 72 of the cutter bits in circumferential row 60f. The right side 70 of cutter bits 44 in circumferential row 60f will align with the left side 72 of cutter bits 44 in circumferential row 60g. Thus, as an example, assuming a cutter bit 44 width of one inch the overall width 110 of the cut made by the cutter assembly 10 in operation will be thirteen inches.

If desired, cutter bits 44 in selected circumferential rows 60 may be removed and replaced with filler plates 64 to generate a desired width and/or pattern of cuts. For example, if a nine inch cut is desired all that is required is to simply remove the cutter bits 44 from outer circumferential rows 60a, 60b, 601, and 60m. The result will be a nine inch cut when the cutter head assembly 10 is in operation. Cutter drum assembly 10 may likewise provide more than one cut at the same time. For example, if two spaced apart equal width cuts of three inches are desired the cutter bits in each of the seven center circumferential rows will be removed and replaced with filler plates 64. In other words, the cutter bits 44 in circumferential rows 60d, 60e, 60f, 60g, 60h, 60i and 60j will be removed. The result will be two spaced apart three inch width cuts.

Cutter bits 44 are also positioned to circumferentially overlap with cutter bits in other horizontal rows. In the embodiment shown there are a plurality of horizontal rows 58. For example, horizontal rows 58 may include a horizontal row 120 that includes four cutter bits across the width of the cutter drum, a horizontal row 122 that includes two cutter bits, a horizontal row 124 that likewise includes two cutter bits 44, a horizontal row 126 that includes three cutter bits 44 and a horizontal row 128 with two cutter bits 44. The pattern will repeat so that there are a plurality of rows 120, 122, 124, 126 and 128. The cutter bits 44 in a horizontal row are spaced laterally from one another. In the embodiment described cutter bits 44 in one horizontal row will circumferentially overlap the cutter bits 44 in a circumferentially adjacent lateral row. For example, as shown in the figures cutter bits 44 in row 126 overlap cutter bits 44 in row 128. Cutter bits 44 in row 128 overlap cutter bits 44 in row 120. Cutter bits 44 in row 120 overlap cutter bits 44 in row 122 and cutter bits 44 in row 122 overlap cutter bits 44 in row 124. Arranging the cutter bits 44 as described herein can provide a cutter drum 15 with a greater number of cutter bits than in prior art arrangements. As a result there is far less wear on cutter bits 44 and the need to replace the cutter bits 44 occurs far less frequently.

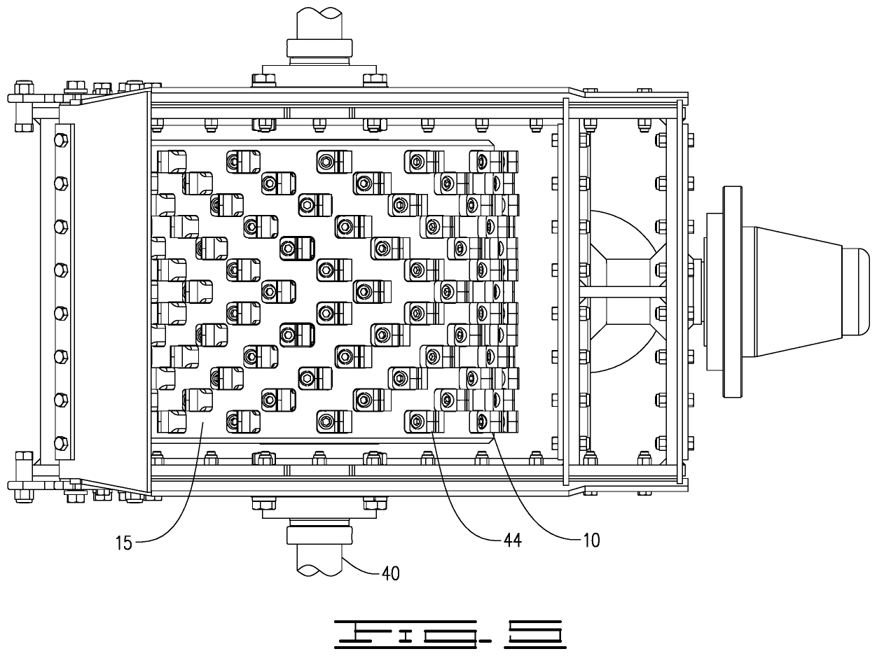

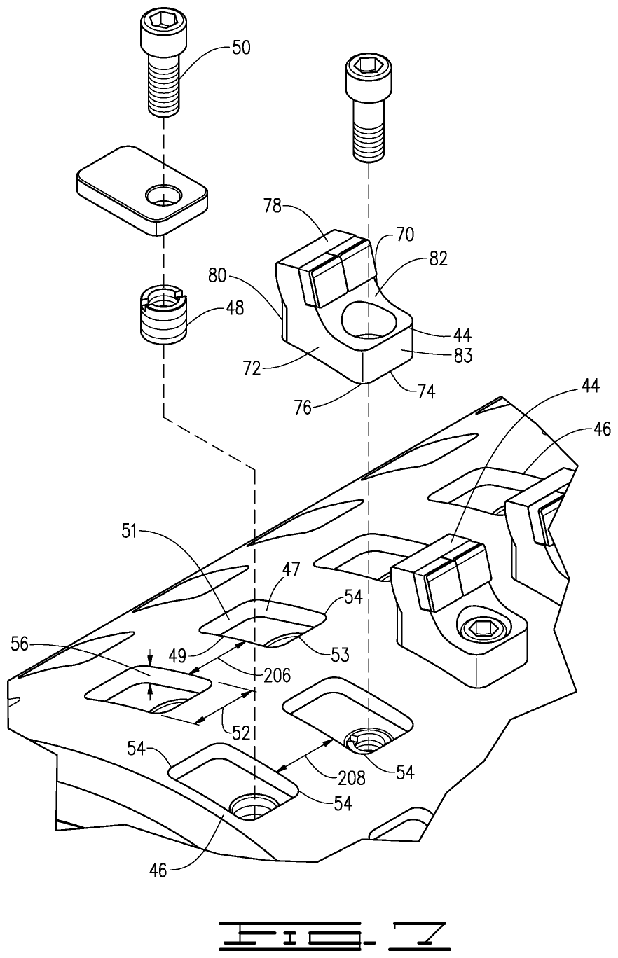

In addition because the cutter tooth 86 is comprised of PCD as described herein replacement is required less frequently that prior art non-PCD cutter bits. Other arrangements of cutter bits 44 are possible, depending on the cut desired. For example, cutter bits may be arranged in horizontal rows 58, circumferential row 60 and in a V-shaped pattern 62 but rather than mounting slots having a right side 47 aligned with the left side 49 of a mounting slot in an adjacent circumferential row the right and left sides 47 and 49 may overlap. Thus the right and left sides 70 and 72 of cutter bits 44 will overlap. Such an arrangement is shown in FIG. 9. There, the right side 70 of a cutter bit 44 in a circumferential row 60 overlaps with the left side 72 of the cutter bits in the adjacent circumferential row 60. The amount of the overlap 302 may vary depending upon the ultimate width of the cut desired. Likewise, the overall width of each cutter bit may be varied. The width of the cut may also be determined simply by providing a narrower cutter drum. An example of a narrower cutter head assembly is shown in FIG. 6.

FIG. 6 shows a cutter head assembly 150 with circumferential rows 60, horizontal rows 58 and V-shaped patterns 62. Cutter head assembly 150 has first and second sides 152 and 154 defining a width 156. First and second side plates 160 and 162 are connected to cutter drum body 158. However, rather than thirteen adjacent circumferential rows the cutter drum head assembly 150 includes nine circumferential rows 60 of mounting slots 46 in drum face 164. In the embodiment of FIG. 6 all mounting slots 46 have cutter bits 44 positioned therein so that the cutter drum assembly 150 has nine circumferential rows of cutter bits 44, identified as circumferential rows 60a-60i. The resulting cut made by the cutter drum assembly 150 would be nine inches, since in the embodiment of FIG. 6 circumferential rows 60 are aligned as described with respect to the embodiment of FIG. 2.

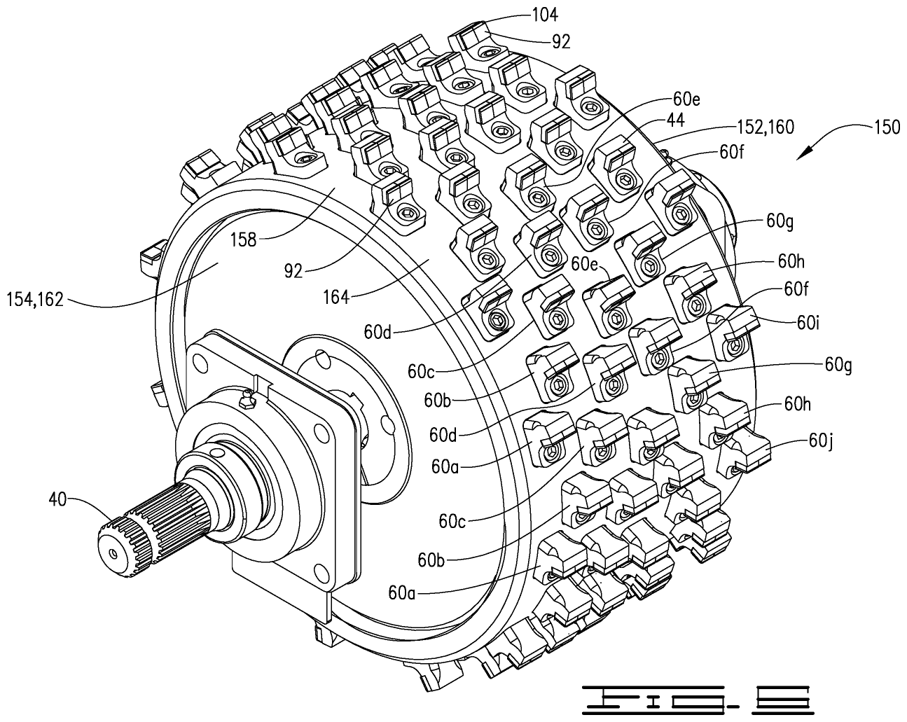

In an alternative arrangement shown in FIGS. 7 and 8 a cutter head assembly 200 is shown. Cutter head assembly 200 includes cutter bits 44 along with mounting slots 46, fasteners 50 and inserts 48. The arrangement of the mounting slots 46 is different than in the embodiments of FIGS. 1 and 6. In the embodiment of FIG. 8 mounting slots 46 are arranged in lateral rows 202 and 204. Lateral rows 202 include mounting slots 46 with a space 206 therebetween while adjacent lateral rows 204 include mounting slots 46 with a space 208 therebetween. Lateral rows 202 and 204 are spaced apart a circumferential distance 209.

Mounting slots 46 in lateral rows 202 are offset from mounting slots 46 in lateral rows 204. Mounting slots 46 in lateral rows 202 are positioned such that the right side 47 thereof is aligned with the left side 49 of the mounting slots 46 in the adjacent lateral rows 204. In other words, width 206 and 208 are identical to the width 52 of a mounting slot 46. Thus, the mounting slots 46 in lateral rows 202 are positioned and configured such that they will fill the space 208 between adjacent mounting slots 46 in rows 204. Likewise, the mounting slots in lateral rows 204 are configured and positioned such that they fill the space 206 between mounting slots 46 and the lateral row 202. There are a plurality of rows 202 and 204 in a repeating pattern.

Cutter head assembly 200 has cutter drum 210 with right and left sides 212 and 214 respectively defining a width 216. The resulting cut is a cut the total width of the cutter bits 44 across cutter drum 210. Thus, assuming cutter bits 44 are mounted in each of mounting slots 46 in the embodiment of FIG. 8, and a cutter bit width of one inch, the cutter drum assembly 200 will make a cut of twelve inches. The width can be varied, as can the number of cuts simply by removing certain of the cutter bits 44. For example the cutter bits may be described as being in circumferential rows 220a-2201. Removing the two rows 220f and 220g will result in spaced apart cuts that are the width of five cutter bits 44, which may be for example one inch in width resulting in two five inch cuts. If a single narrower cut is desired one can remove as few, or as many circumferential rows of cutter bits 44 as desired and replace with rows of filler plates 46. A cut the width of four cutter bits 44 may be made simply by placing filler plates 46 in circumferential rows 220a-220d and 220i-2201. Cutter bits 44 may be arranged in any number of patterns to achieve the desired width of cut.

FIG. 9 shows an arrangement similar to that of FIGS. 1 and 2. However, in the embodiment of FIG. 9, cutter bits 44 in circumferential rows 60 overlap cutter bits 44 in adjacent circumferential rows. Cutter head assembly 300 has horizontal rows 58, circumferential rows 60 and V-shaped patterns 62. Cutter head assembly 300 has seventeen circumferential rows 60a-60q. Horizontal rows 58 may include horizontal rows 120, 122, 124, 126 and a horizontal row 128. The pattern will repeat so that there are a plurality of rows 120, 122, 124, 126 and 128. The number of cutter bits 44 in at least some of the lateral rows is greater than as described with the embodiment of FIG. 1 as a result of the overlap. Cutter head assembly 300 has an overall width 304 between left and right sides 306 and 308.

The mounting slots 46 in each circumferential row 60 overlap the mounting slots 46 in laterally adjacent circumferential rows 60. The amount of the overlap 302 may vary and can be determined based on the width of the desired cut. For example in the embodiment shown, with one inch width cutter bits 44 and a ⅛ inch (0.125″) overlap 302, the overall width of a cut would be thirteen inches. The overlap 302 will prevent the possibility of “corduroy” effect. A corduroy effect may sometimes occur as a result of a slight misalignment of cutter bits 44 or a rounded corner on the cutter bits 44.

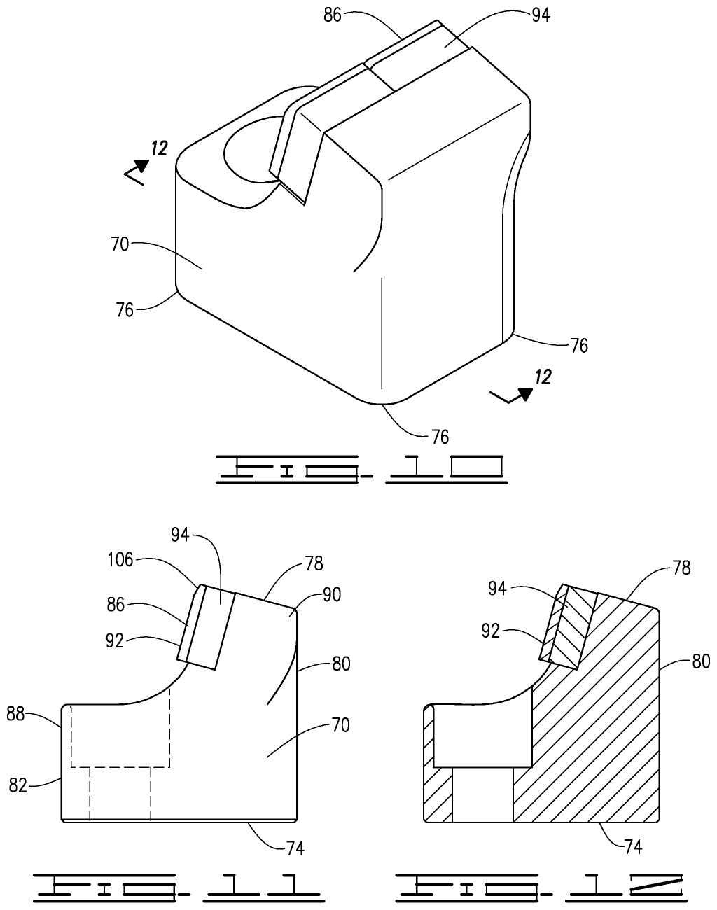

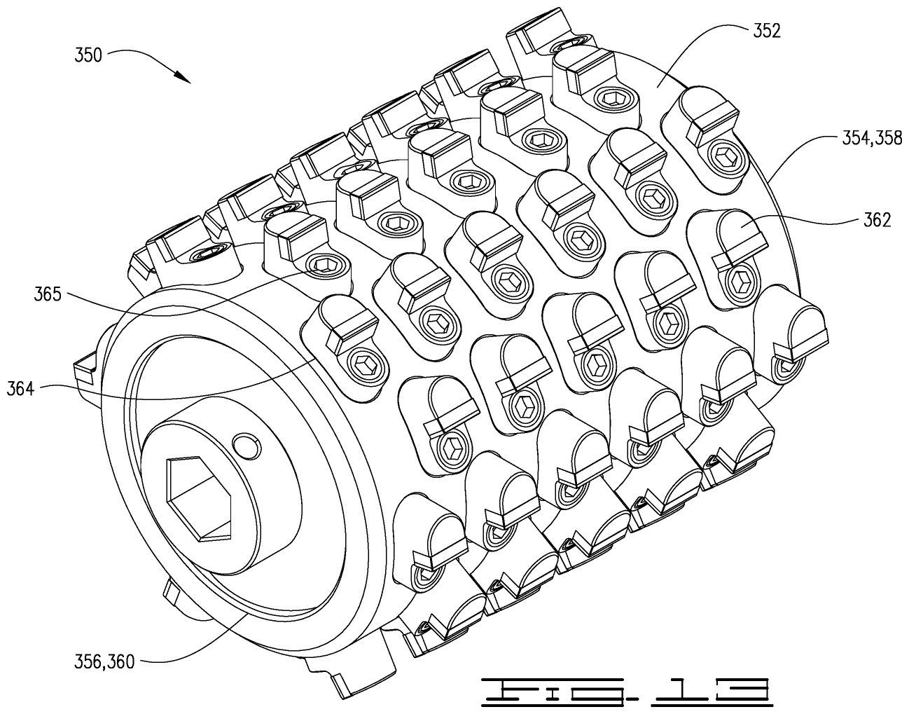

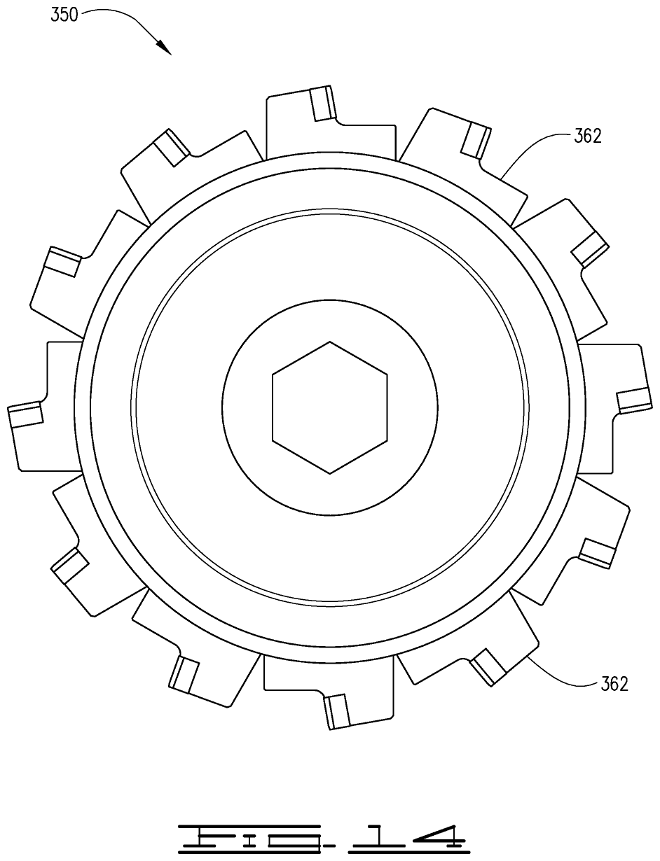

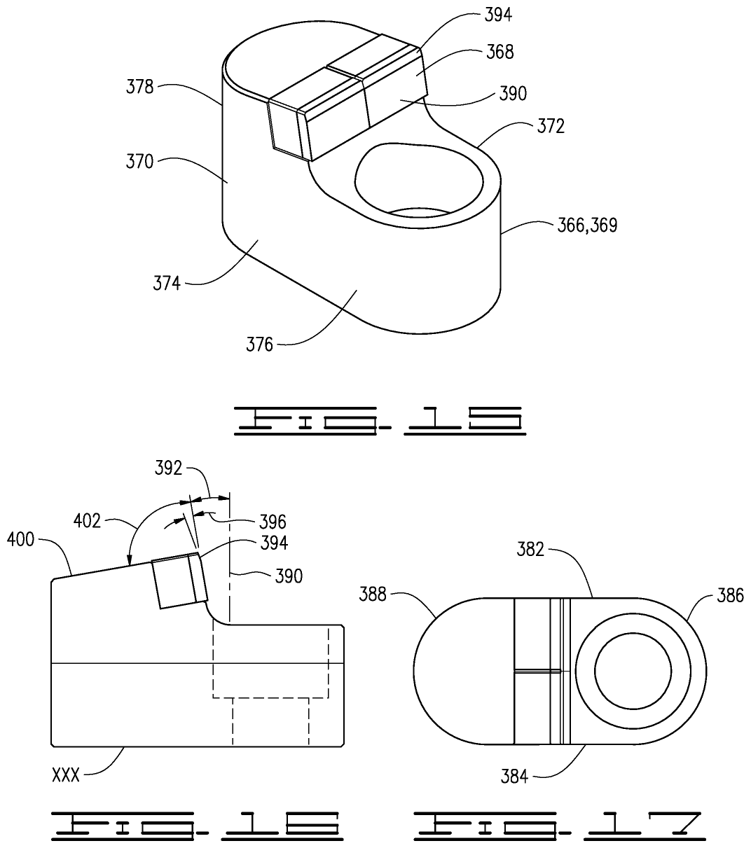

FIG. 13 is a perspective view of an additional cutter head assembly 350. Cutter head assembly 350 comprises a cutter drum 352 with right and left sides 354 and 356, respectively. Cutter head assembly 350 includes a right side plate 358 and a left side plate 360. Cutter head assembly 350 is exemplary of a cutter drum assembly that has a smaller diameter than that previously described and has cutter bits 362 with a profile shown in FIGS. 15-17. Cutter head assembly 350 is connectable to a shaft that will be rotated by a motor as known in the art to cut into a surface with cutter bits 362. The shape of cutter bits 362 is different than that described with respect to cutter bit 44. Cutter bits 362 are disposed in a plurality of mounting slots 364. Mounting slots 364 are shaped so that cutter bits 362 will fit therein and are generally shaped to match the lower surface of cutter bits 362. Cutter bits 362 may be attached with threaded fasteners 365 that will be threaded into inserts (not shown in FIG. 13) in cutter drum 352.

Cutter bits 362 comprise a cutter bit body 366 with a cutter tooth 368 attached thereto. Cutter bit 362 has a front or forward side 369, a rear side 370 and left and right sides 372 and 374, respectively. Body 366 may comprise a base 376 with a tooth portion 378 extending therefrom. Cutter tooth 368 is affixed to tooth portion 378. Base 376 defines a bottom surface 380. Bottom surface 380 has generally what may be called a stadium shape which is rectangle with a pair of semi-circles positioned at opposite ends. In the embodiment shown the bottom surface thus has two sides 382 and 384 and semi-circles 386 and 388 at the front and rear of cutter bit 362.

Cutter tooth 368 has tooth face 391 that is angularly offset from a line 390 perpendicular to bottom surface 380 of cutter bit 362. Angle 392 is in the range of from 8° to 12° and may be about 10°. Cutter tooth 368 has a leading edge 394 that is angularly offset from tooth face 390. The amount of angle 396 is about 10° to 20° and in one embodiment is about 15°. Thus, leading edge 394 is offset in the amount of the sum of angles 392 and 396 from line 392. As described with respect to the embodiment shown in FIGS. 1 and 2, line 392 will be collinear with a line through the center of the cutter drum at the time that cutter bit 362 engages the surface, for example surface 12, is being cut.

Top surface 400 is at an angle 402 from tooth face 391. In one embodiment, angle 402 is from about 85° to 95° and may be for example about 90° Because of the shape and profile of cutter tooth 362, when cutter tooth 368 engages a ground surface to be cut, top surface 400 will not drag as the cutter tooth moves through the cutting arc.

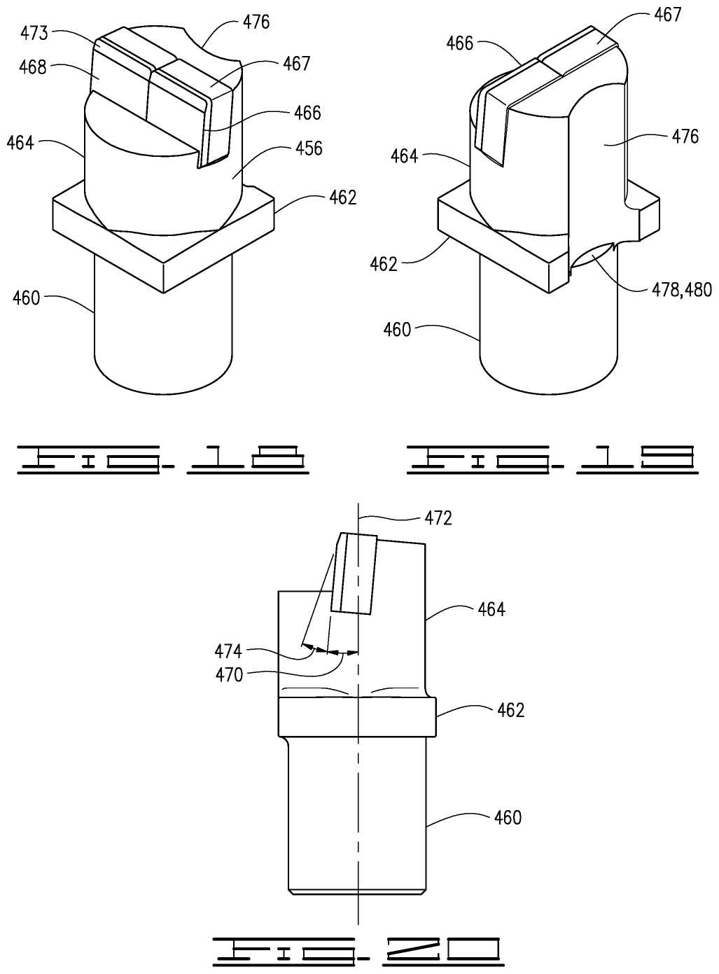

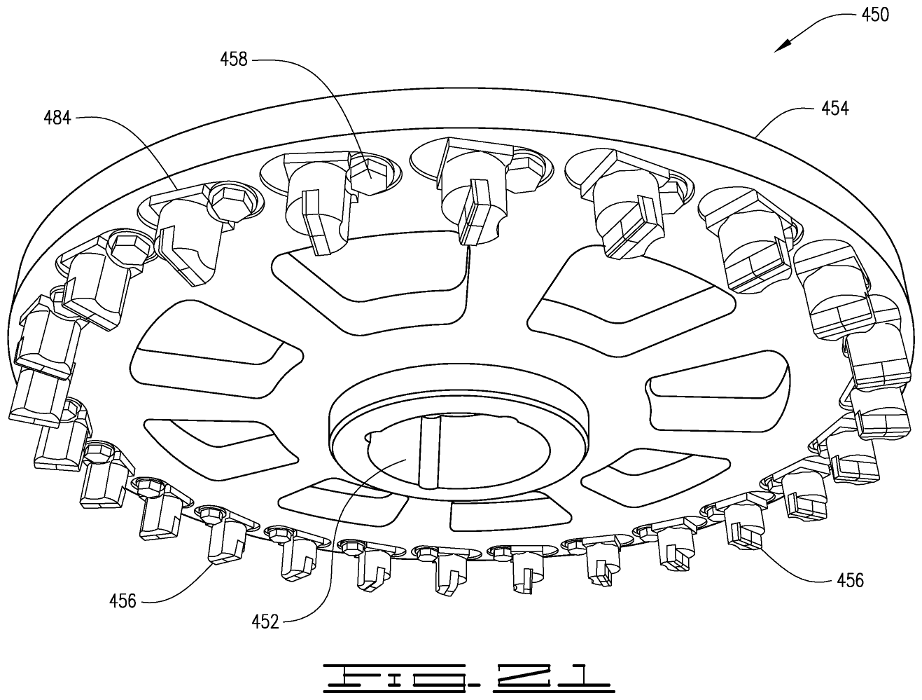

A rotating disc assembly 450 is shown in FIG. 21 with cutter bits 456 connected thereto. Cutter bits 456 are shown in FIGS. 18-20. Rotating disc assembly 450 is a type of disc assembly that may be utilized with, for example, a Rotaplane manufactured by Dickson Industries, Inc. The rotating disc assembly 450 may be utilized to remove a portion of a surface, for example to remove painted lines from roadways. Generally the rotating disc assembly 450 will be mounted with a shaft extending through the center thereof and will rotate about the shaft. The rotating disc assembly 450 will be positioned at an angle from the roadway such that it removes lines or other features desired to be removed and does not leave a sharp edge.

In the embodiment shown rotating disc assembly 450 comprises a disc 454 with an opening 452 therethrough to receive a shaft (not shown). A plurality of cutter bits 456 are mounted to rotating disc assembly 450. Cutter bits 456 are mounted to disc 454 with bolts 458. Bolts 458 will be threaded into an insert (not shown) that is removable and replaceable in disc 454. The insert may be for example like disc 48 described previously.

Cutter bits 456 comprise a shank 460 with a platform 462 at an upper end of the shank 460. A tooth portion 464 extends upwardly from platform 462. A cutter tooth 466, which may be a PCD cutter tooth, attached with a mounting pad 467 is affixed to and forms a part of tooth portion 464. Cutter tooth 466 has a tooth face 468 that is offset by an angle 470 from a line 472 that is a longitudinal center axis 472 of shank 460. Angle 470 may be in the range of 10° to 20° and may be for example 15°. Tooth face 468 has a leading edge 473 that is offset by an angle 474 from tooth face 468. Angle 474 may be for example in the range of 10° to 20° and may be about 15°. An arcuate cutout 476 is defined in a rear portion 477 of tooth portion 464. An engagement tab 478 thus exists at a top 480 of shank 460.

Cutter bits 456 are mounted to rotatable discs 454 by inserting shank 460 into an opening defined in rotatable disc 454. A mounting slot 484 may have for example a stadium shape which is essentially a rectangle with semi-circles at both ends thereof. Threaded bolt 458 will be threaded into an insert (not shown) and will engage tab 478 to hold cutter bits 456 in place. Rotatable disc assembly 450 may therefore be rotated and cutter bits 456 positioned to engage a ground surface to remove a painted line or other feature from a surface such as a roadway. Although described with reference to rotatable disc 450, it is understood that cutter bits 456 may be used with rotating cutter drums.

Thus it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A cutter head comprising:
a drum body having a plurality of mounting slots defined in an outer face of the drum body; and
a plurality of cutter bits removably connected to the drum body in at least a portion of the mounting slots.

2. The cutter head of claim 1 further comprising a filler plate removably connected in any slot in which no cutter bit is received.

3. The cutter head of claim 1, the mounting slots being arranged in circumferential rows, the mounting slots in a circumferential row being positioned to laterally overlap the mounting slots in adjacent circumferential rows.

4. The cutter head of claim 1, each slot being positioned to circumferentially overlap a slot that is laterally spaced therefrom.

5. The cutter head of claim 1, the mounting slots arranged in parallel V-shaped patterns.

6. The cutter head of claim 5, the mounting slots comprising rectangular mounting slots with rounded corners.

7. The cutter head of claim 1 the filler plates and cutter bits connected to the drum with removable fasteners.

8. The cutter head of claim 7, further comprising a plurality of threaded inserts fixed to the cutter drum, the removable fasteners being threaded into the inserts to removably connect the filler plates and the cutter bits to the cutter drum.

9. A cutter head for rotatably connecting to a surface grinding machine comprising:
a cutter drum defining a plurality of mounting slots in an outer face thereof;
a cutter bit mounted in at least some of the mounting slots, the mounting slots arranged such that each mounting slot laterally overlaps at least one laterally adjacent mounting slot.

10. The cutter head of claim 9, the mounting slots arranged such that each mounting slot circumferentially overlaps at least one of the other mounting slots.

11. The cutter head of claim 10, the mounting slots arranged in lateral rows, the mounting slots in a lateral row positioned to circumferentially overlap the slots in the circumferentially adjacent lateral rows.

12. The cutter of claim 9, the mounting slots arranged in V-shaped patterns.

13. The cutter head of claim 9, the cutter bits being removable and replaceable.

14. The cutter head of claim 13, further comprising threaded inserts installed in openings in the mounting slots, the cutter bits connected to the cutter drum with threaded fasteners extending therethrough into the inserts.

15. A cutter head configured to connect to a surface grinding machine comprising:
a drum body;
a plurality of mounting slots defined in a drum face of the drum body, the mounting slots being arranged in circumferential rows;
cutter bits connected in at least some of the mounting slots; and
filler plates connected in at least some of the mounting slots, at least one circumferential row having a filler plate connected in each of the mounting slots therein.

16. The cutter head of claim 15, the at least one circumferential row having a filler plate connected in each of the mounting slots therein being positioned so that the cutter head when in operation will result in two spaced apart cuts.

17. The cutter head of claim 15, the mounting slots comprising generally rectangular slots with rounded corners.

18. The cutter head of claim 15, the slots in a circumferential row laterally overlapping the slots in an adjacent circumferential row.

19. The cutter head of claim 15, the cutter drum body comprising a hollow cutter drum body.

20. The cutter head of claim 15, the mounting slots being arranged in horizontal spaced rows, the mounting slots in a horizontal row positioned to circumferentially overlap mounting slots in another horizontal row.
